(19) United States
(12) Patent Application Publication
(10) Pub. No.: US 2015/0268646 A1
(43) Pub. Date: Sep. 24, 2015

(54) METHODS, ARRANGEMENTS AND DEVICES FOR ANIMAL MANAGEMENT

(71) Applicant: DELAVAL HOLDING AB, Tumba (SE)

(72) Inventor: Sofia Arnerdal, Tumba (SE)

(21) Appl. No.: 14/436,905

(22) PCT Filed: Nov. 5, 2013
(86) PCT No.: PCT/SE2013/051295

§ 371 Date: Apr. 20, 2015

Related U.S. Application Data
(60) Provisional application No. 61/723,366, filed on Nov. 7, 2012.

(30) Foreign Application Priority Data
Nov. 7, 2012 (SE) 1251261-2

(51) Int. Cl. G05B 15/02; A01K 5/02; A01J 5/00; A01K 1/00

(52) U.S. Cl. CPC G05B 15/02; A01K 1/00; A01K 5/02; A01J 5/00

(57) ABSTRACT

An animal management system with a control device configured to control various farm devices, each of the farm devices individually controllable by the control device according to pre-defined settings, where the control device, responsive to a request from a portable device pertaining to a particular animal, is configured to cause a pre-defined setting of a farm device to temporarily change based on the request from the portable device and therefore cause the farm device to operate according to the temporary setting, and subsequently, after an elapse of time or occurrence of an event related to the farm device, revert the setting back to an original setting and cause the farm device to again operate according to the original setting.

### TECHNICAL FIELD

Embodiments of the present invention presented in this disclosure generally relate to farming and, more particularly, arrangements and methods for managing a herd of freely walking animals. More specifically, embodiments presented herein relate to animal management systems, wherein the animal management system comprises a control device configured to control various farm devices of the animal management system and wherein each of the farm devices can be controlled by the control device according to pre-defined settings. Embodiments presented herein also relate to corresponding animal management systems, portable electronic devices, control devices, computer programs and computer program products.

### BACKGROUND

There exist animal management systems for managing a herd of freely walking animals, such as cows. Today, these animal management systems typically comprise a control device and one or several farm devices. As used herein, the expression “farm device” should be understood to mean any device which can be used in the animal management system. Farm devices can thus include devices such as gates (e.g. entry gates, exit gates, identification gates and other gates), guiding devices, feeding devices, separation devices and/or separation gates, examination devices for examining animals, treatment devices for treating animals and milking stations for milking animals. The control device(s) may be configured to control the various farm devices of the animal management system. Typically, the various farm devices are controlled by the control device according to pre-defined settings. To this end, the control device may include a microcomputer, suitable computer program, and a database. In the database, information relating to each animal of the managed area (e.g., the barn) is stored. Such information may include whether an animal with a certain animal identification (ID) has a milking permission or not, whether the animal has permission to enter a certain area or not, etc. Also, the database may include information relating to each of the animals managed in the animal management system.

### SUMMARY

While the above-mentioned animal management system is efficient in many aspects, the present inventors have noted that there is room for continuous improvements.

For example, today's animal management systems may be perceived too static when situations occur, which are not taken into account for by the pre-defined settings. One such situation could, e.g., be that a user observes a leaking milk-producing animal that need to be milked although this particular milk-producing animal does not yet have a milking permission and, thus, pre-defined settings prevent this animal from entering the milking station. Furthermore, since the control device(s) of the existing animal management systems are generally stationary devices which are sometimes physically placed, or located, outside the enclosed area (e.g. a barn) the user cannot generally change any pre-defined settings on the fly, e.g. while walking around in the barn. Instead, s/he has to move to the control device for making any changes of the pre-defined settings and, then, move back to the barn, locate the animal in question again (which may be far from easy) and not until the animal has been found again try to direct the animal in the desired direction. This many be cumbersome and time consuming for the user. With increased demands on animal management systems, the present inventors have therefore realized that there is a need for methods and arrangements that facilitate the management of the freely walking animals and, in turn, makes the management of these animals more efficient.

It is with respect to these considerations and others that the various embodiments of the present invention have been made. It is therefore a general object of the various embodiments of the present invention to provide for improved methods, animal management systems, portable electronic devices, control devices, computer programs, and computer program products. It would be advantageous to provide for methods, animal management systems, portable electronic devices, control devices, computer programs, and computer program products by which one or more of the above-mentioned disadvantages can be mitigated, alleviated or eliminated.

The various embodiments of the invention as set forth in the appended claims address this general object.

According to a first aspect, there is provided a method performed in an animal management system. The animal management system comprises a control device configured to control various farm devices of the animal management system and each of the farm devices is individually controllable by the control device according to pre-defined settings. The method comprises sending a message comprising identification data of an individual animal from a portable electronic device to the control device; sending a request message from the portable electronic device to the control device for requesting the control device to change a pre-defined setting for a specific farm device; receiving, in the control device, the message comprising the identification data; and receiving the request message in the control device, and in response thereto, changing said pre-defined setting temporarily on the basis of the received identification data such that the pre-defined setting is overruled for an individual animal associated with said identification data.

In one embodiment, the pre-defined setting is changed once.

In one embodiment, the pre-defined setting is changed for a limited period of time.

The various farm devices may comprise a feeding device, a gate, a guiding device, a separation device, an examination device, a treatment device and/or a milking station. Also, the above-mentioned specific farm device can be one of the following: a feeding device, a gate, a guiding device, a separation device, an examination device, a treatment device, a milking station.

The portable electronic device may be a handheld electronic device. The handheld electronic device may, e.g., be a mobile telephone, a smart phone or a tablet computer.

According to a second aspect, there is provided an animal management system. The animal management system comprises a control device configured to control various farm devices of said animal management system. Each of the farm devices is individually controllable by the control device according to pre-defined settings. A portable electronic device is configured to send a message comprising identification data of an individual animal to the control device and to send a request message to the control device for requesting the control device to change a pre-defined setting for a specific farm device. The control device is configured to receive the message comprising said identification data and, furthermore, to receive said request message, and in response thereto, change said pre-defined setting temporarily on the basis of the received identification data such that the pre-defined setting is overruled for an individual animal associated with said identification data.

In one embodiment, the pre-defined setting is changed once.

In one embodiment, the pre-defined setting is changed for a limited period of time.

The various farm devices may comprise a feeding device, a gate, a guiding device, a separation device, an examination device, a treatment device and/or a milking station. The specific farm device can, thus, be one of the following: a feeding device, a gate, a guiding device, a separation device, an examination device, a treatment device, a milking station.

The portable electronic device may be a handheld electronic device. The handheld electronic device may, e.g., be a mobile telephone, a smart phone or a tablet computer.

According to a third aspect, there is provided a method for use in an animal management system. The animal management system comprises a control device configured to control various farm devices of the animal management system. Also, each of the farm devices is individually controllable by the control device according to pre-defined settings. This method is performed by a portable electronic device and comprises: sending a message comprising identification data of an individual animal to the control device; and sending a request message to the control device for requesting the control device to change a pre-defined setting for a specific farm device.

The various farm devices may comprise a feeding device, a gate, a guiding device, a separation device, an examination device, a treatment device and/or a milking station. The above-mentioned specific farm device may be one of the following: a feeding device, a gate, a guiding device, a separation device, an examination device, a treatment device, a milking station.

The portable electronic device may be a handheld electronic device. The handheld electronic device may, e.g., be a mobile telephone, a smart phone or a tablet computer.

According to a fourth aspect, there is provided a portable electronic device for use in an animal management system. The animal management system comprises a control device configured to control various farm devices of the animal management system. Furthermore, each of the farm devices is individually controllable by the control device according to pre-defined settings. The portable electronic device comprises a transmitter configured to send, i.e. transmit, a message comprising identification data of an individual animal to the control device and to send, i.e. transmit, a request message to the control device for requesting the control device to change a pre-defined setting for a specific farm device.

The various farm devices may comprise a feeding device, a gate, a guiding device, a separation device, an examination device, a treatment device and/or a milking station. The above-mentioned specific farm device may be one of the following: a feeding device, a gate, a guiding device, a separation device, an examination device, a treatment device, a milking station.

The portable electronic device may be a handheld electronic device. The handheld electronic device may, e.g., be a mobile telephone, a smart phone or a tablet computer.

According to a fifth aspect, there is provided a method for use in an animal management system. The animal management system comprises a control device configured to control various farm devices of said system. Moreover, each of the farm devices is individually controllable by the control device according to pre-defined settings. This method is performed by the control device and comprises: receiving a message comprising said identification data of an individual animal from the portable electronic device; receiving a request message from the portable electronic device, wherein said request message requests the control device to change a pre-defined setting for a specific farm device, and in response thereto changing said pre-defined setting temporarily on the basis of the received identification data such that the pre-defined setting is overruled for an individual animal associated with said identification data.

In one embodiment, the pre-defined setting is changed once.

In one embodiment, the pre-defined setting is changed for a limited period of time.

The various farm devices may comprise a feeding device, a gate, a guiding device, a separation device, an examination device, a treatment device and/or a milking station. Also, the specific farm device mentioned above may be one of the following: a feeding device, a gate, a guiding device, a separation device, an examination device, a treatment device, a milking station.

The portable electronic device may be a handheld electronic device. The handheld electronic device may, e.g., be a mobile telephone, a smart phone or a tablet computer.

According to a sixth aspect, there is provided a control device for use in an animal management system. The control device is configured to control various farm devices of said system. Furthermore, each of the farm devices is individually controllable by the control device according to pre-defined settings. The control device comprises: a receiver configured to receive, from the portable electronic device, a message comprising identification data of an individual animal and furthermore to receive a request message from the portable electronic device, wherein said request message requests the control device to change a pre-defined setting for a specific farm device, and a controller configured to change said pre-defined setting temporarily on the basis of the received identification data such that the pre-defined setting is overruled for an individual animal associated with said identification data.

In one embodiment, the pre-defined setting is changed once.

In one embodiment, the pre-defined setting is changed for a limited period of time.

The various farm devices may comprise a feeding device, a gate, a guiding device, a separation device, an examination device, a treatment device and/or a milking station. Hence, the above-mentioned specific farm device may be one of the following: a feeding device, a gate, a guiding device, a separation device, an examination device, a treatment device, a milking station.

The portable electronic device may be a handheld electronic device. The handheld electronic device may, e.g., be a mobile telephone, a smart phone or a tablet computer.

According to a seventh aspect, there is provided a computer program for use in an animal management system. The animal management system comprises a control device configured to control various farm devices of the animal management system. Furthermore, each of the farm devices is individually controllable by the control device according to pre-defined settings. The computer program comprises computer program code which, when run in a processor of a portable electronic device, causes the portable electronic device to: send, via a transmitter of the portable electronic device, a message comprising identification data of an individual animal to the control device; and send, via the transmitter of the portable electronic device, a request message to the control device for requesting the control device to change a pre-defined setting for a specific farm device.

According to an eight aspect, there is provided a computer program product comprising a computer program according to the seventh aspect and a computer-readable means on which the computer program is stored.

The portable electronic device may be a handheld electronic device. The handheld electronic device may, e.g., be a mobile telephone, a smart phone or a tablet computer.

### BRIEF DESCRIPTION OF THE DRAWINGS

These and other aspects, features and advantages of the invention will be apparent and elucidated from the following description of embodiments of the present invention, reference being made to the accompanying drawings, in which:

FIG. 1 shows a schematical view from above of an example animal management system;

FIG. 2 is a view of an example milking stall of the system in FIG. 1;

FIG. 3 is a view of a pen and a separation gate associated with a milking stall such as the milking stall of FIG. 2;

FIG. 4 is a flow chart illustrating a method performed in an animal management system according to an embodiment of the invention;

FIG. 5 shows flow charts illustrating a method performed in a portable electronic device according to various embodiment of the invention;

FIG. 6 is a schematic diagram illustrating some modules of a portable electronic device according to an embodiment of the invention;

FIG. 7 schematically shows one example of a computer program product comprising computer readable means;

FIG. 8 shows flow charts illustrating a method performed in a control device according to an embodiment of the invention; and

FIG. 9 is a schematic diagram of some modules of a control device according to an embodiment of the invention.

### DETAILED DESCRIPTION

The invention will now be described more fully hereinafter with reference to the accompanying drawings, in which certain embodiments of the invention are shown. The invention may, however, be embodied in many different forms and should not be construed as limited to the embodiments set forth herein; rather, these embodiments are provided by way of example so that this disclosure will be thorough and complete, and will fully convey the scope of the invention to those persons skilled in the art. Like numbers refer to like elements throughout the description.

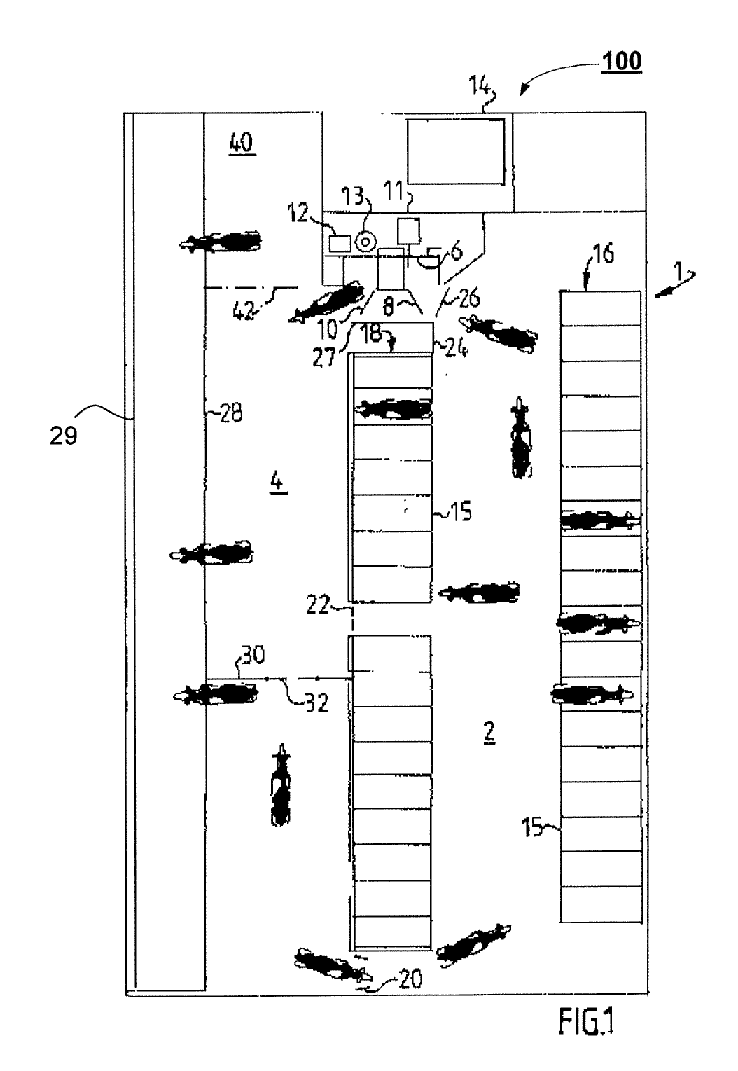

FIG. 1 is a schematic view from above illustrating an example environment where embodiments of the present invention can be applied. An animal management system 100 for managing a herd of freely walking animals is provided. The animal management system 100 is comprised of an enclosed area 1, in which area the animals can move about freely. In the following description reference will be made to cows only. It should however be evident that embodiments of the present invention can also be applied to other animals, especially milk-producing animals such as sheep, goats, buffaloes and horses to name a few examples.

The enclosed area 1 may for example be an indoor area such as a barn. Alternatively, the enclosed area 1 may be an outdoor area, which may be enclosed by a fence or the like. Yet further, the enclosed area 1 could be a combination of an indoor and an outdoor area.

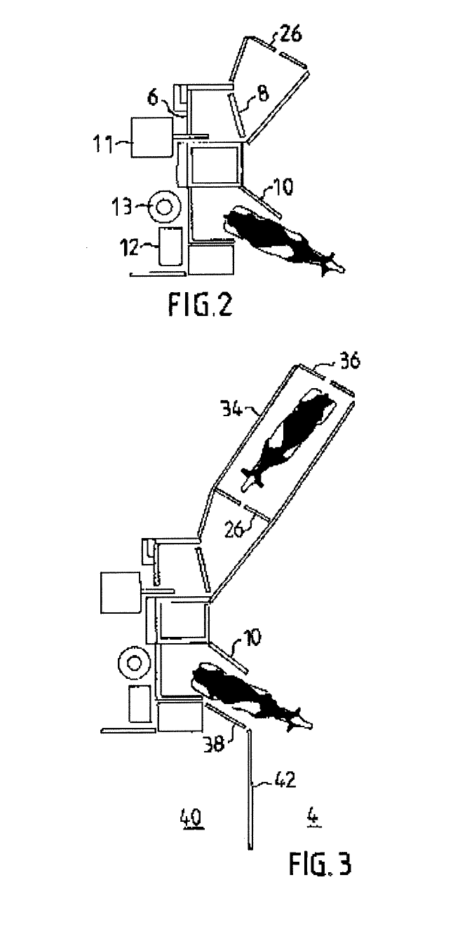

In the illustrated example, the enclosed area 1 is divided into a resting section 2 and a feeding section 4. A milking station 6, or milking stall, is located at one end of the enclosed area 1. The details of the milking station 6 are elucidated in FIG. 2. As can be seen in FIG. 2, the milking station 6 may be provided with an entrance gate 8 and an exit gate 10. The milking station 6 comprises an automatic milking machine 11, which is provided with a robot arm for applying teat cups (not shown) on the teats of a cow present in the stall. The automatic milking machine 11 is connected to a control device 12, and optionally additional equipment, for controlling the robot arm and for collecting the extracted milk. To this end, a milk receiver 13 and a milk tank 14 may also be provided. The milk receiver 13 and the milk tank 14 may be provided as two separate units as in this example or as one single unit.

The resting section 2 may comprise a plurality of boxes 15 arranged one after another in two parallel lines 16 and 18, respectively. The first line 16 may for example be located adjacent to a surrounding wall or fence in the resting section 2 of the enclosed area 1.

The second line 18 may be divided between the resting section 2 and the feeding section 4. An optional number of passageways provided with gates, in this example first 20, second 22 and third 24 identification gates are arranged at the second line 18 to selectively allow cows to pass from one section to the other. This way, the first 20, second 22 and third 24 identification gates can be used to control where the managed cows are allowed to move. Depending on identification data (ID) of the cow, the identification gates 20, 22, 24 selectively allow (or reject) cows to enter from one section to the other.

Additionally, a fourth identification gate 26 may be arranged in a passageway between the entrance gate 8 and the resting section, to selectively allow cows to pass said passageway. The fourth identification gate 26 may be arranged between the end of the second line 18 of boxes, which is close to the milking station 6 and a wall, or fence 27, of the milking station 6. As can be seen from FIG. 1, the entrance gate 8 and the exit gate 10 are associated with the milking station 6. The entrance gate 8 and the exit gate 10 may be arranged to allow a cow to enter and exit, respectively, the milking station 6 when the gates 8 and 10 are in a first state and to stop, or prevent, cows from entering to and exit from, respectively, when the gates 8, 10 are in a second state. The milking station 6 may be closed by the gates 8, 10 when in said second state. Hence, a cow is allowed to pass in either direction through a passageway between the resting section 2 and feeding section 4, the passageway being formed between the closed gates 8, 10 of the milking station and the wall 27, or fence, of the milking station 6, provided that at the same time the cow in question is allowed to pass through the fourth identification gate 26.

The feeding section 4 may be equipped with a feeding passage 28 alongside a second surrounding wall or fence, which is opposite to the first surrounding wall in the resting section 2. The feeding passage may comprise a feeding device 29 for supplying the feeding passage 28 with e.g. fodder, concentrate and water. The feeding section 4 may be divided into two or more subsections, by means of one or more dividing walls 30, or fences, in which a fifth identification gate 32 is located, to selectively allow the cows to pass from one subsection to another.

FIG. 3 discloses an embodiment of a milking station in FIG. 2, in which the passageway between the entrance gate 8 and the resting section 2 is prolonged over the fourth identification gate 26 by means of a waiting box 34. A sixth identification gate 36 is located at the free end of the waiting box towards the resting section 2, to selectively allow the cows to enter into the waiting box 34. Even if shown in FIG. 3, it may be convenient to omit the identification gate 26 as not being necessarily required for identification purposes in this particular case with the waiting box 34. Furthermore, a separation gate or other separation device 38 may be associated with the milking station 6 adjacent to the exit gate 10 and arranged to guide cows with a differing status to a separation section 40, which may be arranged in the feeding section 4 by means of a separating wall 42, or separating fence. In some embodiments, the separation section 40 is used for examination and/or treatment purposes. To this end, the separation section 40 may include one or several examination devices (not shown in FIG. 3) for examining the condition of the cows. Yet further, one or a plurality of treatment devices (not shown in FIG. 3) for treating a cow may also be provided. Any kind of treatment may be performed on the cow which has been separated into the separation section 40. The treatment might be any medical treatment, for example curing a disease by an injection. It might also be insemination or, even, manual milking in the case that an automatic milking did not succeed. Yet further, it might be applying an earmark or even that the cow should be separated to be brought to slaughtery. Separated cows may be manually or automatically transferred from the separation section 40 by means of a not shown gate.

The gates that are illustrated in the system 100, e.g. the entrance gate 8, the exit gate 10, the separation gate 38 and the first to sixth identification gates 20-26, 32 and 36 respectively, may be of any conventionally used kind. For example, each gate may be maneuverable by means of the control device 12 between a first state, in which a cow is allowed to pass through the gate and a second state, in which a cow is stopped by the gate. Each gate may be open and/or unlocked in its first state and closed and/or locked in its second state. Hence the gates may be of a hinged-, sliding- or revolving-door type and with a single or a double door-blade design, such as a “saloon-door” type. When unlocked the latter gate may be pressed open by a cow and urged to a closed position by means of a spring load or by gravity force. The gates may be provided with a conventional gate operating and locking equipment, e. g. which is electrically, pneumatically, hydraulically, mechanically maneuvered or combinations thereof.

Each of the gates 8, 10, 20-26, 32 and 36 may furthermore be provided with a not shown transponder reader of a common kind, which is capable of instantly identifying a transponder carried by each cow, when the cow reports at the appropriate gate. For example, transponder techniques such as the technique described in European Patent no. EP 1 614 268 B1 can be used. The control device 12 may thus generate signals corresponding to the relevant appearance and status of the cows at the gates, e.g. the movements of the cows may be monitored in dependence of whether a cow is stopped or let through a specific gate. The above-mentioned gates are namely preferably designed to allow a cow to pass in one direction or the other and may be equipped with a transponder reader capable of detecting the passing direction of the cow. Alternatively or in combination with a transponder reader, the identification gates may be provided with sensors, e.g. photo-cells, or cameras on each side of each gate for the same purpose. Accordingly, a cow, which is due for milking and reports at the gate 8 (or, alternatively, 26 which is located at the entrance gate 8), is identified by means of its transponder and the transponder reader or sensor associated with the gate. If the milking stall 6 is free and available said cow is allowed to enter and a milking sequence is initiated. If not the cow is alternatively allowed to pass by the milking stall to the feeding section 4 or stopped at the gate, depending on if the cow is due for feeding or not.

If a cow is reporting at any side of any of the other gates of the system, the cow is stopped or allowed to pass the gate depending on the present status of the cow. Therefore, it is even possible for the cow to pass one gate in one direction and then change its mind and return in the other direction through the same gate. Moreover the cow may pass through several gates in different directions or may be stopped by more than one gate. Consequently, it is for example possible to separate a cow with the status “alarm cow” from the herd and keep it in the separation section 40. It is even possible to assemble all cows in one of the subsections on either side of the dividing wall 30, if one part of the feeding passage 28 of the feeding section 4 needs to be cleaned up.

For the management and control of the animal management system 100, the above-mentioned control device 12 is provided. The control device 13 is connectable to the various farm devices such as gates (e.g. entrance gate 8 and the exit gate 10, and the identification gates 20, 22, 24, 26). The control device is also connectable to farm devices such as the milking station 6 and parts thereof, e.g. the automatic milking machine 11. The control device is also connectable to farm devices such as examination devices (not shown in FIGS. 1-3) and treatment devices (not shown in FIGS. 1-3). Furthermore, the control device 12 may be connected to feeding devices 29, etcetera. Each of the above-mentioned, and other, farm devices may be individually controlled by the control device 12 according to pre-defined settings. In other words, the control device 12 is configured to control the various farm devices of the system 100.

The example animal management system 100 of FIG. 1 illustrates many different farm devices. However, the person skilled in the art appreciates that there exist more conceivable farm devices than those farm devices specifically discussed with reference to FIG. 1. For example, the animal management system 100 may include one or several guiding devices (sometimes also referred to as selection gates or selection gate arrangements). As is known by persons skilled in the art, a guiding device is a box-like device where a cow enters the box-like device, is identified by means of identification means and is furthermore directed in one or another direction, e.g., on the basis of the identification and, thus, the status of the individual cow associated with the identification. One example guiding device is disclosed in U.S. Pat. No. 7,874,263 (cf guiding device 25 disclosed this patent). Further example implementations of guiding devices (or, selection gate arrangements) are described in U.S. Pat. No. 5,628,284 and in international patent application WO 2004/068940.

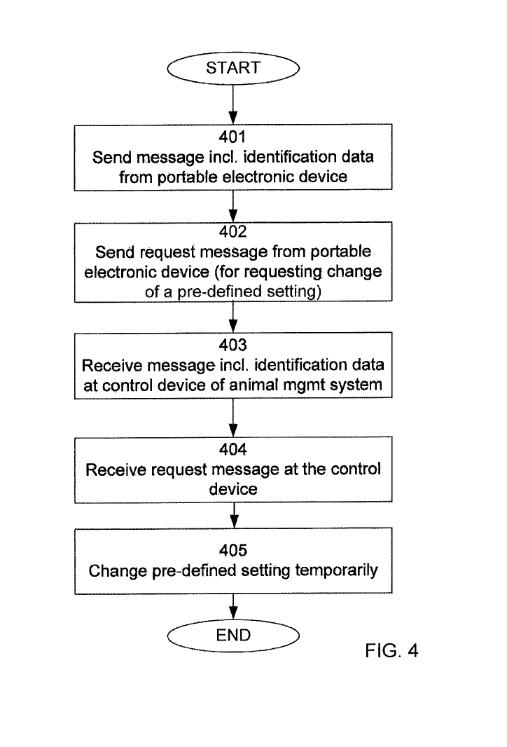

FIG. 4 is a flow chart illustrating a method performed in an animal management system such as the animal management system 100 illustrated in FIGS. 1-3. With reference to FIG. 1-3 and FIG. 4, an exemplary embodiment of the present invention will now be described.

According to this embodiment, a user (typically, but not necessarily, a farmer) uses a portable electronic device (not shown in FIGS. 1-3). In contrast to stationary devices, the portable electronic device is capable of being carried, or moved, from one place to another. Generally, the portable electronic device can be carried, or moved, with ease. Preferably, the portable electronic device is smart phone. Alternatively, the portable electronic device may be a mobile telephone or a cellphone. In yet other embodiments, the portable electronic device may be a tablet computer.

As will be further detailed herein, the portable electronic device is configured to send a message comprising identification data of an individual animal to the control device 12.

Furthermore, the portable electronic device is configured to send a request message to the control device 12 for requesting the control device 12 to change a pre-defined setting for a specific farm device. The control device 12 is configured to receive the message comprising said identification data. Also, the control device 12 is configured to receive the request message. In response thereto, the control device is capable of, or operable to, change said pre-defined setting temporarily on the basis of the received identification data. Accordingly, the pre-defined setting can be overruled for an individual animal, which is associated with the identification data. The communication of messages, e.g. the above-mentioned messages, between the portable electronic device and the control device 12 is preferably, but not necessarily, wireless. The wireless communication may comply with any or a combination of UMTS (Universal Mobile Communications System), CDMA2000 (Code Division Multiple Access 2000), LTE (Long Term Evolution), LTE Advanced, GSM (Global System for Mobile Communications), WLAN (Wireless Local Area Network), Wi-Fi, etcetera. Alternatively, the wireless communication could be according to a proprietary wireless communication protocol between the portable electronic device and the control device 12 provided by the provider, or manufacturer, of the animal management system 100.

In an initial step, step 401, the user operates his or her portable electronic device to send a message comprising identification data of an individual animal to the control device 12. The identification data may be any data suitable for identifying an individual animal. Thus, the identification data may for example be an identification number associated with the animal in question.

In some embodiments, the user operates his or her portable electronic device to manually type in, via the user interface of the portable electronic device, an identification number associated with the animal in question. In other embodiments, the user may operate his or her portable electronic device to select a cow in question from a displayed list of managed cows (which may be displayed via the user interface of the portable electronic device). When the user has selected a cow from the displayed list of cows or when the user has manually typed in the identification number of the cow, the identification data of the individual animal can be sent 401 from the portable electronic device to the control device 12.

In alternative embodiments, each of the managed cows of the animal management system 100 may comprise an individual identification (ID) tag, wherein the tag comprises identification data in the form of, e.g., an ID number. Each cow of the managed cows can thus be associated with an individual ID tag. The ID tags can hence be used as identifiers of the cows. For example, prior to step 401, the method may additionally comprise reading the ID number from the ID tag associated with the individual animal. To this end, the portable electronic device may include a reader, e.g. in the form of a camera, or scanner, for reading the ID number of the ID tag. The user can operate his or her portable electronic device to take a snapshot (i.e., read) the ID number of the ID tag attached to an individual animal. When the ID number has been read, the user can continue operating his or her portable electronic device to send 401 the thus read identification data associated with the ID tag to the control device.

In yet other embodiments, each of the managed cows of the animal management system 100 may comprise an individual optical representation of data. The optical representation of data may for example be attached to a surface of an already carried transponder, which is typically carried by each cow of an animal management system 100. The optical representation of data may, e.g., be a so-called Quick Response, QR, code. Some general principles of QR codes are discussed in the European Patent, EP 0 672 994 B1. Each cow of the managed cows can thus be associated with an individual QR code. The QR codes can hence be used as identifiers of the cows. For example, prior to step 401, the method may additionally comprise reading the optically readable representation of data, e.g. the QR code, associated with the individual animal. To this end, the portable electronic device may include a reader, e.g. in the form of a QR code reader for reading the QR code. The reader may thus also comprise a camera. The user operates his or her portable electronic device to take a snapshot (i.e., read) the QR code attached to an individual animal. This individual QR code comprises identification data of the individual animal and, hence, identifies the cow from which the QR code is read. When the QR code has been read, the user can continue operating his or her portable electronic device to send 401 any identification data (that is embedded or otherwise comprised in the QR code) to the control device.

Next, in step 402, the user operates his or her portable electronic device to send a request message from the portable electronic device to the control device for requesting the control device to change a pre-defined setting for a specific farm device.

Subsequently, in step 403, the control device 12 receives the message comprising the identification data. Also, in a next step 404, the control device 12 receives the request message. In response thereto, the control device can change, in step 406, the pre-defined setting temporarily on the basis of the received identification data such that the pre-defined setting is overruled for an individual animal associated with the identification data.

It should be appreciated that the above-mentioned method steps described with reference to FIG. 4 need not be performed in this specific order. For example steps 401 and 402 need not be performed in this specific order. Step 402 may be performed prior to step 401. Also, the steps 401 and 402 need not be performed as two separate steps, but rather as one single step where the message comprising the identification data and the request message are sent in one single message. Similarly, step 404 may be performed prior to step 403. Further, the steps 403 and 404 need not be performed as two separate steps, but rather as one single step. Accordingly both messages, i.e. the message comprising identification data and the request message, may be received substantially simultaneously in one single step. Other orders than those specifically described here could also be envisaged.

In order to elucidate some of the advantages of various embodiments of the present invention various scenarios will be described. In the animal management system 100, there are numerous gates denoted 8, 10, 20, 22, 24, 26. Each of the gates is individually controllable by the control device 12 according to pre-defined settings. The control device 12 may include a database of the cows that are managed within the area of the animal management system 100. Furthermore, the control device 12 includes the pre-defined settings for each of the individually controlled gates. In other words, each of the gates is controlled in dependence of these pre-defined settings, or gate-instructions. Thus, gates can e.g. be opened or closed in dependence of the pre-defined settings. This way, it is possible to pre-define, or set, direction rules for each of the gates. Consequently, it could be said that the gates determine which route the cows should, or could, take within the enclosed area 1 of the animal management system 100.

When a user (typically a farmer) walks freely in the enclosed area 1, s/he may for example discover that a particular cow needs to be let into the milking station although this particular cow does not currently have a milking permission. The user may thus decide that s/he wants to drive this cow to the entrance gate 8 of the milking station 6. The user, who has brought, his/her portable electronic device (e.g. a mobile phone or a smart phone) operates a user interface (e.g. a touch screen display) of the portable electronic device to send 401 a message comprising identification data (e.g. cow-ID) of the particular cow to the control device 12. To this end, the user may for example operate the portable electronic device through the user interface thereof to select a cow identification (ID) associated with the cow in question. For example, a list of cow IDs representing all managed cows in the system 1 may be output, i.e. displayed or otherwise presented, at the user interface of the portable electronic device. The user then operates the user interface to select the cow ID in question from the list of all cow IDs. A message comprising the selected cow ID can thus be sent to the control device 12 by operating the user interface of the portable electronic device.

Furthermore, the user operates the user interface of portable electronic device to send 402 a request message to the control device 12 for thereby requesting the control device to change the pre-defined setting for entrance gate 8. This can, e.g., be done at the time when the user has driven the cow to the entrance gate 8 and the cow is about to enter the milking station 6.

In subsequent steps, 403 and 404, the control device 12 receives the messages from the portable electronic device. That is, the control device 12 receives the message comprising the above-mentioned cow-ID and a request message requesting the control device to change the pre-defined setting for the particular gate, i.e. entrance gate 8 in this example scenario.

Generally, the control device 12 is configured to control, in accordance with pre-defined settings, the entrance gate 8 based on an identification checking. In particular, the control device 12 is provided to control the entrance gate 8 to allow each of the cows which is checked and found to have a milking permission to enter the milking station by opening the gate 8, and to prevent each of the cows which is checked and found not to have milking permission from entering.

In a next step 405, and in accordance with embodiments of the present invention, the pre-defined setting for the entrance gate 8 is temporarily changed on the basis of the received identification data of the individual cow, e.g. a cow-ID. That is, the pre-defined setting of the entrance gate 8 is overruled (e.g., changed from close gate to open gate) for the individual cow associated with the received cow-ID. Hence, when the particular cow approaches the entrance gate 8, the cow will be identified by the entrance gate 8 (or, alternatively, the optional identification gate 26) to be the particular cow associated with the cow-ID and, thus, be given access to the milking station 6 by opening the entrance gate 8 (although the information stored in the control device 12 indicates that the particular cow does not have milking permission and, thus, would normally have been prevented from entering the milking station 6). In a preferred embodiment, the pre-defined setting is overruled only once. In other words, the pre-defined setting is overruled only until the cow in question leaves the milking stall 6 and passes through the exit gate 10 to enter the feeding section 4. Or said differently, the pre-defined setting is overruled until the cow in question leaves the relevant location, i.e. the milking stall 6 in this example. Consequently, if the user wants to change the pre-defined setting more times, e.g. twice, s/he will have to initiate the desired change each new time s/he desires a change by operating the user interface of his/her portable electronic device. This way, the predefined setting is not permanently changed, or overruled. Instead, the pre-defined setting is changed (overruled) only temporarily. In some embodiments, the pre-defined setting is changed for a limited period of time. The limited period of time can, e.g., be set to any suitable period of time. As a mere example, the limited time period can be set to any suitable period of time on the basis of collected historical data on average durations of how long time cows normally stay in the milking stall during milking.

The above scenario discusses the control and management of a gate 8. However, as will be appreciated upon reading this disclosure various embodiments of the present invention are not limited to gates only. For example, in another example scenario the user, e.g. the farmer, observes a cow that seems to need to be examined and, potentially, treated by some medical treatment. The user may thus want to direct the cow to the separation section 40 (although the information stored in the control device 12 indicates that the particular cow does not need examination nor treatment). In a similar manner as described above with respect to the other scenario, the user operates his or her portable electronic device to send 401 a message comprising identification data (e.g. cow-ID) of this particular cow to the control device 12. Then the user operates the user interface of portable electronic device to send 402 a request message to the control device 12 for thereby requesting the control device to change the pre-defined setting for separation gate 38. This can, e.g., be done at the time when the user has driven the cow to the separation gate 38 (see FIG. 3). Moreover, the user operates the user interface of portable electronic device to send 402 a request message to the control device 12 for thereby requesting the control device to temporarily change the pre-defined setting of an examination device such that, when the cow in question enters the separation zone 40, the cow can be examined by said examination device. If the examination performed by the examination device reveals that the cow needs any kind of treatment, the user can continue operating the user interface of his or her portable electronic device to change the pre-defined setting of a certain treatment device such that the cow in question can be treated when the cow enters, or approaches, the treatment device in question.

In yet another exemplary scenario, the milking stall 6 may include equipment for light treatment. If the user, e.g. the farmer, observes a cow that seem to need light treatment the user can operate the portable electronic device to send identification data of the identified particular cow to the control device 12. Furthermore, the user may send a request message to the control device 12 to activate the equipment for light treatment (i.e. temporarily change the pre-defined setting of the equipment for lighting) next time this particular cow enters the milking station 6 for milking purposes.

As will be appreciated upon reading this disclosure, there exist even more scenarios and the various embodiments of the present invention are not limited to the above specific scenarios. Instead, it should be appreciated that any farm device which is individually controllable by the control device 12 can advantageously be operated in substantially the same or a similar manner to temporarily change a pre-defined setting of the controlled farm device.

According to the various embodiments of the present invention, a user can change a pre-defined setting of an individually controllable farm device easily by operating his/her portable electronic device while walking freely in the enclosed area 1 of an animal management system. S/he can do so from anywhere and at anytime s/he finds most convenient. This gives the user flexibility. Moreover, the user does not necessarily have to walk the distance to the control device 12, which is sometimes located outside the enclosed area 1 of the animal management system, each time s/he wants to change settings of a particular farm device. Instead, s/he can change the pre-defined setting by operating his/her portable electronic device while on the fly, e.g. when walking around inside the enclosed area 1. This also provides improved flexibility for the user.

Especially when a user wants to drive a cow to the milking station (as in the above example scenario with the gate 8) and the user furthermore wants, at the same time, to change the setting for a gate at the milking station it certainly helps the user if the user does not have to walk to the control device 12 for changing the pre-defined settings, but can instead operate the portable electronic device while moving or driving the cow in question to the milking station 6.

Further flexibility can be achieved by those embodiments where the user operates his or her portable electronic device to read an ID tag or, alternatively, an optically readable representation of data (e.g. a QR code). These embodiments may allow for less manual input by the user, which in turn may allow for reducing the risk of errors. Instead of manually entering identification data of cows or to scroll lists of managed cows by operating the user interface of the portable electronic device, these embodiments allow for merely reading the ID tag or the optically readable representation of data (from a cow) and send the identification data to the control device.

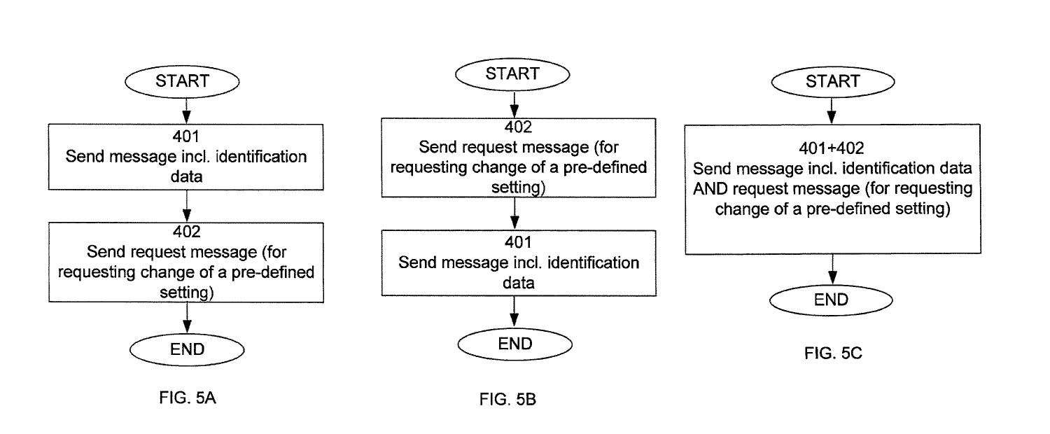

FIG. 5A is a flow chart illustrating a method performed in portable electronic device according to an embodiment of the invention.

In step 401, a message comprising identification data (e.g. cow-ID or the identification data embedded or otherwise comprised in the above-mentioned ID tag or optically readable representation of data) of an individual cow is sent to a control device 12. Next, in subsequent step 402, a request message is sent to the control device 12 for requesting the control device to change a pre-defined setting for a specific farm device.

FIG. 5B is a flow chart illustrating a method performed in portable electronic device according to an alternative embodiment of the invention. The method shown in FIG. 5B is similar to the method of FIG. 5A, but the method steps are performed in the reverse order. That is, method step 402 is performed prior to step 401.

FIG. 5C is a flow chart illustrating a method performed in portable electronic device according to yet another embodiment of the invention. The method shown in FIG. 5C is similar to the methods of FIGS. 5A and 5B, but the method steps 401 and 402 are performed in one single step. That is, method steps 401 and 402 are performed simultaneously, or at least substantially simultaneously.

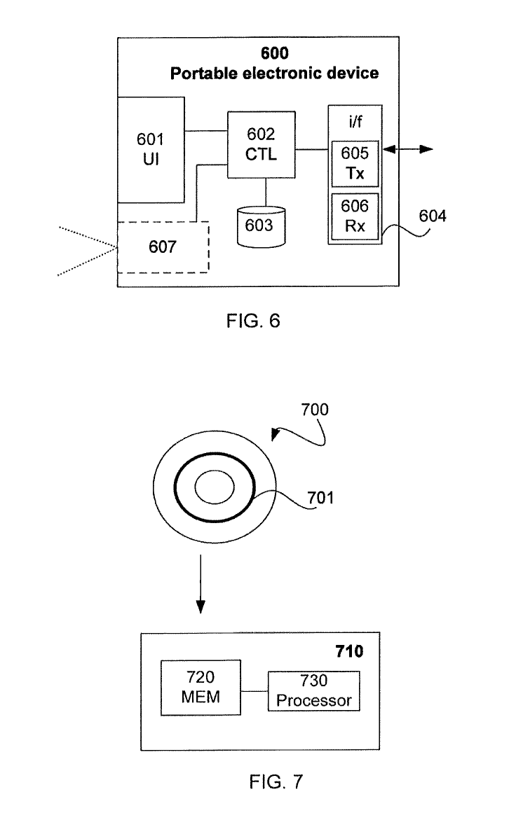

FIG. 6 illustrates an example portable electronic device 600 according to some embodiments of the present invention. The example portable electronic device 600 may, for instance, be configured to perform some or all of the method steps described with respect to the hereinabove-discussed methods according to FIGS. 5A, 5B and 5C, respectively.

The portable electronic device 600 is especially suitable for use in an animal management system, such as the system 100 shown in FIGS. 1-3, i.e. a system which comprises a control device 12 configured to control various farm devices of the system and wherein each of the farm devices is individually controllable by the control device 12 according to pre-defined settings. The portable electronic device 600 is operable in any or a combination of UMTS (Universal Mobile Communications System), CDMA2000 (Code Division Multiple Access 2000), LTE (Long Term Evolution), LTE Advanced, GSM (Global System for Mobile Communications), WLAN (Wireless Local Area Network), Wi-Fi, etcetera. Alternatively, or additionally, the portable electronic device may be operable to communicate wirelessly with the control device 12 to a proprietary wireless communication protocol.

The portable electronic device 600 is preferably, but not necessarily, a mobile telephone or a smart phone. Alternatively, the portable electronic device may be a tablet computer or the like. The portable electronic device 600 illustrated in FIG. 6 comprises a user interface (UI) 601, a processor 602, a memory 603, and communication interface 404. The communication interface 604 comprises a sender 605, or transmitter, as well as a receiver 606.

The UI 601 preferably, but not necessarily, comprises a touch screen display. The touch screen display may comprise any known touch screen display that may be configured to enable touch recognition by any suitable technique, such as, for example, capacitive, resistive, infrared, strain gauge, surface wave, optical imaging, dispersive signal technology, acoustic pulse recognition, and/or other suitable touch recognition techniques. Accordingly, the touch screen display may be operable to be in communication with the processor 602 to receive an indication of a user input in the form of a touch interaction, e.g., a contact between the touch screen display and an input object (e.g., a finger, stylus, pen, pencil, and/or the like). The touch screen display may further be operable to be in communication with the processor 602 to provide an output, such as graphical output, to the user.

The processor 602 may be provided using any suitable central processing unit (CPU), microcontroller, digital signal processor (DSP), etc., capable of executing computer program comprising computer program code, the computer program being stored in the memory 603. The memory 603 may be any combination of random access memory (RAM) and read only memory (ROM). The memory may also comprise persistent storage, which, for example, can be any single one or combination of magnetic memory, optical memory, or solid state memory or even remotely mounted memory.

According to this embodiment, the memory 603 stores computer program comprising computer program code which, when run in the processor 602, causes the portable electronic device 600 to send a message comprising identification data of an individual animal to a control device, and furthermore to send a request message to the control device for requesting the control device to change a pre-defined setting for a specific farm device. To this end, the portable electronic device 600 also comprises a sender 605, or transmitter. The transmitter 605 is configured to send, i.e. transmit, the message comprising identification data of the individual animal. Also, the transmitter 602 is configured to send the request message to the control device for requesting the control device to change the pre-defined setting. The portable electronic device 600 may also comprise a receiver 602 for receiving messages, e.g. from the control device 12. The sender 601 and the receiver 602 may be part of a common communication interface 603, or circuitry.

In some embodiments, the portable electronic device 600 may additionally comprise a reader 607 operatively connected to the processor 602. The reader is configured to read either a ID number from a ID tag or an optically readable representation of data associated with the individual cow, as described hereinabove. The reader 607 may comprise a scanner. Additionally, or alternatively, the reader 607 may comprise a camera for taking a photo, or snapshot, of the ID tag or the optically readable representation of data.

It should be noted that units described as separate units in the context of FIG. 6 may, in some embodiments, be comprised in a single physical or functional unit. Similarly, a unit described as a single physical or functional unit in the context of FIG. 6 may, in some embodiments, be implemented as several separate physical or functional units.

FIG. 7 schematically shows one example of a computer program product 700 comprising computer readable means 701. On this computer readable means 701, a computer program can be stored. The computer program may be loadable into a data-processing unit, or processor 730, which may, for example, be comprised in a portable electronic device 710. When loaded into the processor 730, the computer program may be stored in a memory 720 associated with or integral to the processor 730. According to some embodiments, the computer program may, when loaded into and run by the processor 730, cause the processor to execute method steps according to, for example, the methods described hereinabove with reference to FIGS. 5A, 5B and 5C, respectively.

In this illustrative example, the computer program product is an optical disc, such as a CD (compact disc), a DVD (digital versatile disc) or a blue-ray. However, in preferred embodiments the computer-readable means can also be solid state memory, such as flash memory or a software package (also sometimes referred to as software application, application or app) distributed over a network, such as the Internet.

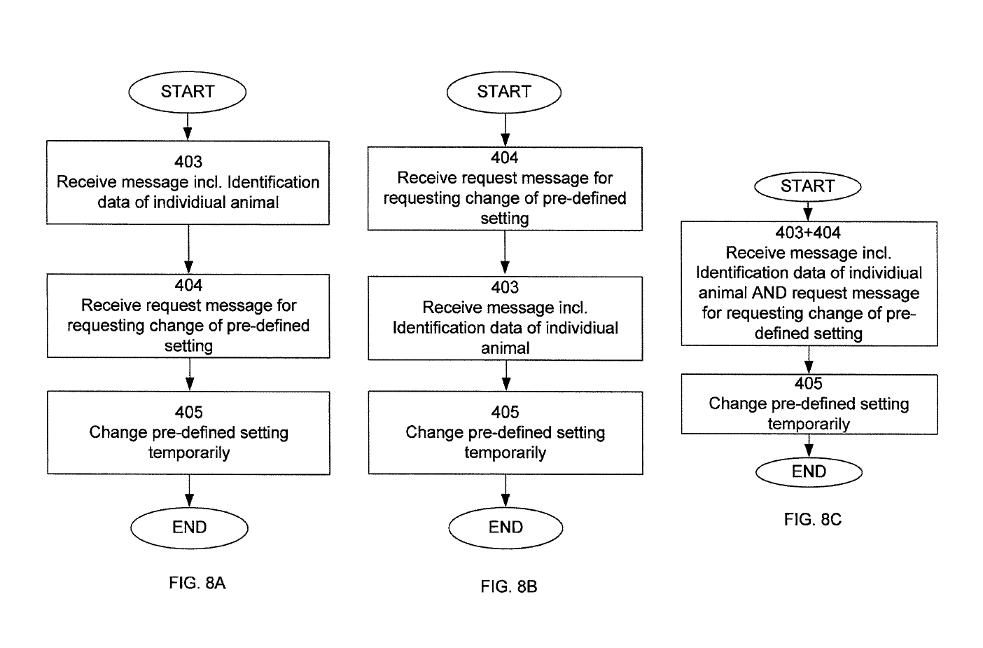

FIG. 8A is a flow chart illustrating a method performed in a control device, e.g. control device 12 in FIG. 1, according to an embodiment of the invention. In an initial step 403 a message comprising identification data (e.g., cow-ID) of an individual animal, e.g. a cow, is received. Also, in a further step 404, a request message for requesting the control device 12 to change a pre-defined setting associated with a particular farm device is received. In subsequent step 405, the pre-defined setting is changed temporarily on the basis of the received identification data such that the pre-defined setting is overruled for an individual animal associated with the received identification data. The pre-defined setting is changed (overruled, or overridden) only temporarily as described hereinabove. Alternatively, it may be changed for a limited period of time. The limited period of time can, e.g., be set to any suitable period of time.

FIG. 8B is a flow chart illustrating a method performed in a control device according to an alternative embodiment of the invention. The method shown in FIG. 8B is similar to the method of FIG. 8A, but the method steps 403 and 404 are performed in the reverse order. That is, method step 404 is performed prior to step 403.

FIG. 8C is a flow chart illustrating a method performed in a control device according to a yet another embodiment of the invention. The method shown in FIG. 8C is similar to the methods of FIGS. 8A and 8B, but the method steps 403 and 404 are performed in one single step. That is, method steps 403 and 404 are performed simultaneously, or at least essentially simultaneously.

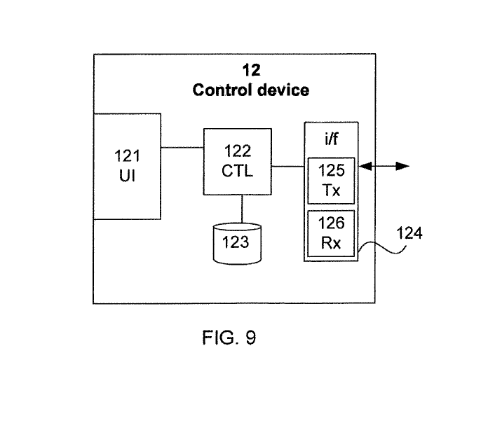

FIG. 9 illustrates a control device 12 according to some embodiments of the present invention. The control device 12 may, for instance, be configured to perform some or all of the method steps described with respect to the hereinabove-discussed methods according to FIGS. 8A, 8B and 8C, respectively.

The control device 12 is especially suitable for use in an animal management system, such as the system 1 shown in FIG. 1. The control device 12 is configured to control various farm devices (e.g. gates 8, 10, 20, 22, 24, 26, milking station 6 or parts thereof, examination devices, separation devices 38 or gates, examination devices, treatment devices, etc.) of the animal management system 1. Hence, each of the farm devices of the system 1 is individually controllable by the control device 12 according to pre-defined settings. Furthermore, the control device may be operable in any or a combination of UMTS (Universal Mobile Communications System), CDMA2000 (Code Division Multiple Access 2000), LTE (Long Term Evolution), LTE Advanced, GSM (Global System for Mobile Communications), WLAN (Wireless Local Area Network), Wi-Fi, etcetera. Alternatively, or additionally, the portable electronic device may be operable to communicate wirelessly with the control device 12 to a proprietary wireless communication protocol.

The example control device 12 illustrated in FIG. 9 comprises a user interface (UI) 121, a processor or controller 122, a memory 123, and communication interface 124. In this example, the communication interface 124 comprises a sender 125, or transmitter, as well as a receiver 126.

The controller 122 may be provided using any suitable central processing unit (CPU), microcontroller, digital signal processor (DSP), etc., capable of executing computer program comprising computer program code, the computer program being stored in the memory 123. The memory 123 may be any combination of random access memory (RAM) and read only memory (ROM). The memory may also comprise persistent storage, which, for example, can be any single one or combination of magnetic memory, optical memory, or solid state memory or even remotely mounted memory.

According to this embodiment, the receiver 126 is configured to receive, e.g. from a portable electronic device, a message comprising identification data of an individual animal (e.g. a cow-ID or the like as discussed earlier). Furthermore, the receiver 126 is configured to receive a request message, wherein this request message requests the control device to change a pre-defined setting for a specific farm device. The receiver 126 is operatively connected to the controller 122 and the controller 122 is configured to change the pre-defined setting temporarily on the basis of the received identification data. Thus, a specific pre-defined setting can be changed (i.e. overruled, or overridden) temporarily for an individual animal associated with said identification data.

It should be noted that units described as separate units in the context of FIG. 9 may, in some embodiments, be comprised in a single physical or functional unit. Similarly, a unit described as a single physical or functional unit in the context of FIG. 9 may, in some embodiments, be implemented as several separate physical or functional units.

Various embodiments of the present invention described throughout this disclosure provide for improved methods, animal management systems, portable electronic devices, control devices, computer programs, and computer program products. A user can change a pre-defined setting of an individually controllable farm device with ease by operating his/her portable electronic device while walking freely in the enclosed area 1 of an animal management system. S/he can do so from anywhere and at anytime s/he finds most convenient. This gives the user flexibility. Moreover, the user does not necessarily have to walk the distance to the control device 12 each time s/he wants to change settings of a particular farm device. Instead, s/he can change the pre-defined setting by operating his/her portable electronic device while on the fly, e.g. when walking around inside the enclosed area 1. This also provides improved flexibility for the user. To name only one example, when a user wants to drive a cow to the milking station 6 (as in one of the herein described scenarios) and the user furthermore wants, at the same time, to change the setting for a gate at the milking station 6 it certainly helps the user if the user does not have to exit the enclosed area to walk to the control device 12 for changing the pre-defined settings, but can instead operate the portable electronic device while moving or driving the cow in question to the milking station 6. As is understood, various embodiments of the present invention may allow for facilitated management of freely walking animals. The management of these animals can thus be made more efficient.

Although the present invention has been described above with reference to specific embodiments, it is not intended to be limited to the specific form set forth herein.

Rather, the invention is limited only by the accompanying claims and, other embodiments than the specific above are equally possible within the scope of the appended claims. For instance, although individual features may be included in different embodiments, these may possibly advantageously be combined, and the inclusion of different embodiments does not imply, in any way, that a combination of features from different embodiments is not feasible and/or not advantageous. Yet further, while certain embodiments have been described to include various components, not all illustrated components need to be included in order to implement the various embodiments of the invention. As a mere example, the control device 12 was described to include a user interface although a user interface is not necessary for implementing the inventive concept of the various embodiments of this invention. Furthermore, the described embodiments of the invention and their equivalents may be realized in software or hardware or a combination thereof. They may be performed by general-purpose circuits associated with or integral to a device, such as digital signal processors (DSP), central processing units (CPU), co-processor units, field-programmable gate arrays (FPGA) or other programmable hardware, or by specialized circuits such as for example application-specific integrated circuits (ASIC). All such forms are contemplated to be within the scope of the present invention.

As used herein, the term “comprise/comprises” and “include/includes” do not exclude the presence of other elements or steps. Furthermore, although individual features may be included in different claims, these may possibly advantageously be combined, and the inclusion of different claims does not imply that a combination of features is not feasible and/or advantageous. In addition, singular references do not exclude a plurality. Reference signs in the claims are provided merely as a clarifying example and should not be construed as limiting the scope of the claims in any way.

1-34. (canceled)

35. A method performed in an animal management system that has a control device configured to control various farm devices of said system, each of the farm devices being individually controllable by the control device according to pre-defined settings, the method comprising:
storing, in a memory of the animal management system, a plurality of pre-defined settings pertaining to each of the farm devices with respect to individual animals served by each device, each of the farm devices being controlled for each of the individual animals by the management system in accordance with the pre-defined settings;
sending (402) an identification message comprising identification data of an individual animal from a portable electronic device to the control device;
sending (403) a request message from the portable electronic device to the control device for requesting the control device to change a pre-defined setting of the pre-defined settings pertaining to a specific farm device with respect to the individual animal;
receiving (404), in the control device, the identification message comprising the identification data;
receiving (405) the request message in the control device;
responsive to receiving the identification message and the request message, changing (406), at the control device, a pre-defined setting, from a first setting, to a second setting based on the request message, and subsequently controlling the specific farm device to operate in accordance with the second setting; and
automatically causing, at the control device, in response to the passing of a predetermined period of time and/or an occurrence of an event related to the specific farm device, the pre-defined setting pertaining to the specific farm device and the individual animal to revert from the second setting to the first setting, and subsequently controlling the specific farm device to operate in accordance with the first setting.

36. The method according to claim 35, wherein the various farm devices comprises a feeding device, a gate, a guiding device, a separation device, an examination device, a treatment device and/or a milking station.

37. The method according to claim 35, wherein the specific farm device is one of the following: a feeding device, a gate, a guiding device, a separation device, an examination device, a treatment device, a milking station.

38. The method according to claim 35, wherein the portable electronic device is a handheld electronic device such as a mobile telephone, smart phone or tablet computer.

39. An animal management system (100), said system (100) comprising:
a control device (12) configured to control various farm devices (6, 8, 10, 11, 20, 22, 24, 26, 29, 36, 38) of said system (100), each of the farm devices (6, 8, 10, 11, 20, 22, 24, 26, 29, 36, 38) being individually controllable by the control device (12) according to pre-defined settings; and
a portable electronic device (600) configured to send a message comprising identification data of an individual animal to the control device (12) and to send a request message to the control device (12) for requesting the control device (12) to change a pre-defined setting for a specific farm device (6, 8, 10, 11, 20, 22, 24, 26, 29, 36, 38) with respect to said individual animal,
wherein, upon receipt at the control device (12) of the message comprising said identification data and said request message, said control device causes said pre-defined setting temporarily change, from a first setting, to a second setting based on the received identification data, and cause the specific farm device to operate according to the second setting, and
wherein, in response to the passing of a predetermined period of time and/or an occurrence of an event related to the specific farm device, said control device causes said pre-defined setting to revert from the second setting back to the first setting, and causes the specific farm device to operate according to the original setting.

40. The system according to claim 39, wherein the various farm devices comprises a feeding device (29), a gate (8, 10, 20, 22, 24, 26, 36, 38), a guiding device, a separation device (38), an examining device, a treatment device and/or a milking station (6).

41. The system according to claim 39, wherein the specific farm device is one of the following: a feeding device (29), a gate (8, 10, 20, 22, 24, 26, 36, 38), a guiding device, a separation device (38), an examination device, a treatment device, a milking station (6).

42. The system according to claim 39, wherein the portable electronic device is a handheld electronic device such as a mobile telephone, smartphone or tablet computer.

43. A method for use in an animal management system that has a control device configured to control various farm devices of said system, each of the farm devices being individually controllable by the control device according to pre-defined settings, the method comprising:
storing, in a memory of the animal management system, a plurality of pre-defined settings pertaining to each of the farm devices with respect to individual animals served by each device, each of the farm devices being controlled for each of the individual animals by the management system in accordance with the pre-defined settings;
in the control device, receiving (404) an identification message comprising said identification data of an individual animal from a portable electronic device;
in the control device, receiving (405) a request message, from the portable electronic device, for requesting the control device to change a pre-defined setting of the pre-defined settings pertaining to a specific farm device with respect to the individual animal,
in the control device, causing said pre-defined setting to change, from a first setting, to a second setting based on the received identification data, and causing the specific farm device to operate according to the second setting; and
in the control device, in response to the passing of a predetermined period of time and/or an occurrence of an event related to the specific farm device, causing said pre-defined setting to revert from the second setting back to the first setting, and causing the specific farm device to operate according to the original setting.

44. The method according to claim 43, wherein the various farm devices comprises a feeding device, a gate, a guiding device, a separation device, an examining device, a treatment device and/or a milking station.

45. The method according to claim 43, wherein the specific farm device is one of the following: a feeding device, a gate, a guiding device, a separation device, an examination device, a treatment device, a milking station.

46. The method according to claim 43, wherein the portable electronic device is a handheld electronic device such as a mobile telephone, smartphone or tablet computer.

47. A control device (12) for use in an animal management system, comprising:
a controller configured to control various farm devices of said system, each of the farm devices being individually controllable by the controller according to pre-defined settings, stored in a memory of the controller, pertaining to each of the farm devices with respect to individual animals served by each device, each of the farm devices being controlled for each of the individual animals by the controller in accordance with the pre-defined settings; and a receiver (126) configured to configured to receive, from a portable electronic device, an identification message comprising identification data of an individual animal and a request message from the portable electronic device that requests the control device to change a pre-defined setting of the pre-defined settings pertaining to a specific farm device with respect to the individual animal,
wherein the controller (122) is configured to, responsive to the identification message and the request message, change said pre-defined setting temporarily from a first setting to a second setting based on the received identification data and cause the specific farm device to operate according to the second setting, and
wherein the controller is configured to, responsive to the passing of a predetermined period of time and/or an occurrence of an event related to the specific farm device, cause said pre-defined setting to revert from the second setting back to the first setting, and cause the specific farm device to operate according to the original setting.

48. The control device according to claim 47, wherein the various farm devices comprises a feeding device, a gate, a guiding device, a separation device, an examining device, a treatment device and/or a milking station.

49. The control device according to claim 47, wherein the specific farm device is one of the following: a feeding device, a gate, a guiding device, a separation device, an examination device, a treatment device, a milking station.

50. The control device according to claim 47, wherein the portable electronic device is a handheld electronic device such as a mobile telephone, smartphone or tablet computer.
